(19) United States
(12) Patent Application Publication
(10) Pub. No.: US 2025/0113275 A1
(43) Pub. Date: Apr. 3, 2025

(54) MOBILE DEVICE ROAMING BETWEEN NON-TERRESTRIAL AND TERRESTRIAL NETWORKS

(71) Applicant: AT&T Intellectual Property I, L.P., Atlanta, GA (US)

(72) Inventors: Yupeng Jia, Austin, TX (US); Hongyan Lei, Plano, TX (US)

(21) Appl. No.: 18/478,984

(22) Filed: Sep. 29, 2023

(51) Int. Cl. H04W 36/14; H04W 36/30; H04W 84/06

(52) U.S. Cl. CPC H04W 36/14; H04W 36/30; H04W 84/06

(57) ABSTRACT

A method includes monitoring a condition of a mobile device while the mobile device is connected to a terrestrial network, determining that the condition satisfies a trigger for switching to a non-terrestrial network, and sending, in response to the determining, a first instruction to the mobile device, where the first instruction causes the mobile device to disconnect from the terrestrial network and to connect to a non-terrestrial network.

The present disclosure relates generally to mobile networks and relates more particularly to devices, non-transitory computer-readable media, and methods for enabling mobile devices to roam between non-terrestrial and terrestrial networks.

### BACKGROUND

In the field of mobile communications, roaming refers to the ability of a mobile device (e.g., a mobile phone, a tablet computer, a laptop computer, a drone, an autonomous vehicle, an Internet of Things device, a mobile gaming system, or the like) to connect to another service provider's network when the mobile device travels beyond the geographical coverage area of the mobile device's native network (e.g., the network operated by the service provider to whose services the mobile device is subscribed). This allows the mobile device to maintain network connectivity and to continue to use mobile applications and services in a substantially uninterrupted manner, regardless of the mobile device's physical location.

### SUMMARY

In one example, the present disclosure describes a device, computer-readable medium, and method for enabling mobile devices to roam between non-terrestrial and terrestrial networks. For instance, in one example, a method includes monitoring a condition of a mobile device while the mobile device is connected to a terrestrial network, determining that the condition satisfies a trigger for switching to a non-terrestrial network, and sending, in response to the determining, a first instruction to the mobile device, where the first instruction causes the mobile device to disconnect from the terrestrial network and to connect to a non-terrestrial network.

In another example, a non-transitory computer-readable medium stores instructions which, when executed by a processor, cause the processor to perform operations. The operations include monitoring a condition of a mobile device while the mobile device is connected to a terrestrial network, determining that the condition satisfies a trigger for switching to a non-terrestrial network, and sending, in response to the determining, a first instruction to the mobile device, where the first instruction causes the mobile device to disconnect from the terrestrial network and to connect to a non-terrestrial network.

In another example, a device includes a processor and a computer-readable medium storing instructions which, when executed by the processor, cause the processor to perform operations. The operations include monitoring a condition of a mobile device while the mobile device is connected to a terrestrial network, determining that the condition satisfies a trigger for switching to a non-terrestrial network, and sending, in response to the determining, a first instruction to the mobile device, where the first instruction causes the mobile device to disconnect from the terrestrial network and to connect to a non-terrestrial network.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for enabling mobile device roaming between non-terrestrial and terrestrial mobile networks, in accordance with the present disclosure;

FIG. 3 illustrates a flowchart of an example method for enabling mobile device roaming between non-terrestrial and terrestrial mobile networks, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure enables mobile devices to roam between non-terrestrial and terrestrial networks. As discussed above, roaming refers to the ability of a mobile device (e.g., a mobile phone, a tablet computer, a laptop computer, a drone, an autonomous vehicle, an Internet of Things device, a mobile gaming system, or the like) to connect to another service provider's network when the mobile device travels beyond the geographical coverage area of the mobile device's native network (e.g., the network operated by the service provider to whose services the mobile device is subscribed). This allows the mobile device to maintain network connectivity and to continue to use mobile applications and services in a substantially uninterrupted manner, regardless of the mobile device's physical location.

Roaming between multiple terrestrial networks or TNs (i.e., networks for which a majority, if not all, of the physical infrastructure is anchored to the Earth's surface, such as Fourth Generation long term evolution (4G LTE) and Wi-Fi networks) has been commonplace for decades; however, even as Fifth Generation (5G) deployment continues, it remains a challenge to provide adequate coverage and to support roaming in more remote physical locations. Moreover, because the physical infrastructure of conventional TNs is anchored to the Earth's surface, the coverage that TNs can provide to mobile devices that are removed from the Earth's surface (e.g., mobile devices operated by users who are traveling in airplanes, drones, etc.) is limited.

Examples of the present disclosure improve the coverage provided to mobile devices by enabling seamless roaming between TNs and non-terrestrial networks or NTNs (i.e., networks for which at least a portion of the physical infrastructure is not anchored to the Earth's surface, such as satellite networks and networks that utilize unmanned aerial vehicles or high-altitude platform systems to provide broadband links). In one example, roaming between TNs and NTNs may be triggered based on a current value of one or more quality of experience metrics (e.g., coverage, loading, services, or cost), in order to optimize the one or more quality of experience metrics for a mobile device. In another example, roaming between TNs and NTNs may be triggered based on the current altitude of a mobile device.

Moreover, although examples of the present disclosure are largely discussed within the context of roaming between TNs and NTNs, examples of the present disclosure may also be used to facilitate roaming between two or more NTNs (e.g., two or more NTNs comprising different types of networks or providing different coverage) or between two or more TNs (e.g., as is currently conventional) if such roaming is determined to optimize the one or more quality of experience targets.

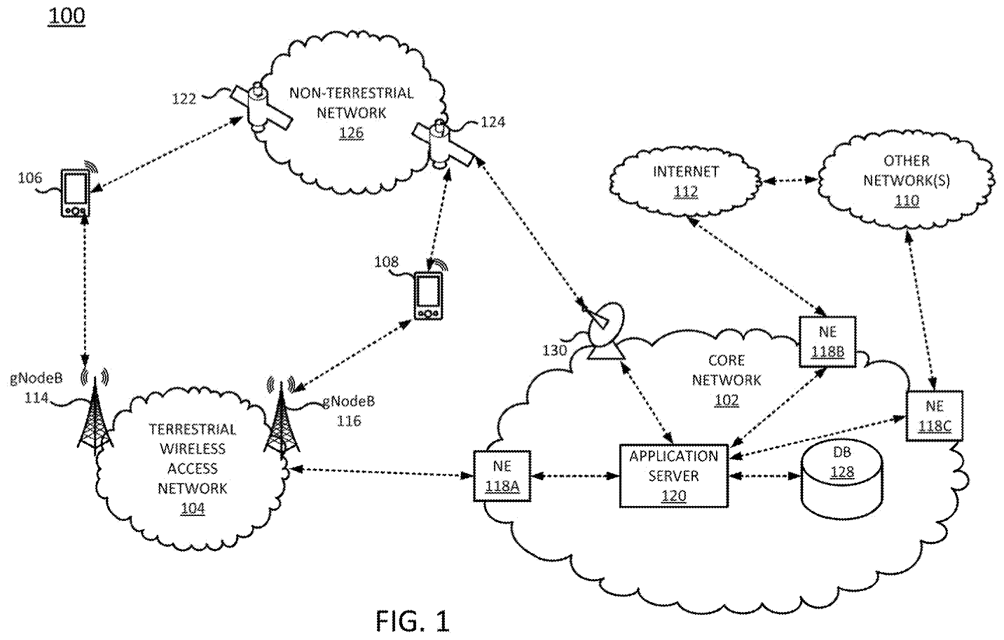

Thus, within the context of the present disclosure, the term “roaming” is used to refer to a mobile device disconnecting from a network element in a first network and connecting to a network element in a second network. The first network and second network may be operated by the same service provider or may be operated by two different service providers. Moreover, the first network and the second network may be the same type of network (e.g., both TNs or both NTNs) or may be two different types of networks (e.g., one TN and one NTN). These and other aspects of the present disclosure are discussed in greater detail in connection with FIGS. 1-4, below.

To better understand the present disclosure, FIG. 1 illustrates an example network 100, related to the present disclosure. As shown in FIG. 1, the network 100 connects mobile devices 106 and 108, as well as potentially other devices, with one another and with various other devices via a core network 102, a wireless access network 104 (e.g., a cellular network), other networks 110 and/or the Internet 112.

In one example, wireless access network 104 comprises a terrestrial network, such as a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 104 may comprise an access network in accordance with any “second generation” (2G), “third generation” (3G), “fourth generation” (4G), Long Term Evolution (LTE), “fifth generation” (5G), next-generation radio access network (NG-RAN), or any other yet to be developed future wireless/cellular network technology including beyond 5G and further generations. While the present disclosure is not limited to any particular type of wireless access network, in the illustrative example, wireless access network 104 is shown as a UMTS terrestrial radio access network (UTRAN) subsystem. Thus, elements 114 and 116 may each comprise a next generation Node B (gNodeB).

In one example, each of the mobile devices 106 and 108 may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like. In one example, any one or more of mobile devices 106 and 108 may have both cellular and non-cellular access capabilities and may further have wired communication and networking capabilities.

As illustrated in FIG. 1, network 100 includes a core network 102. In one example, core network 102 may combine core network components of a cellular network with components of a triple play service network; where triple play services include telephone services, Internet services and television services to subscribers. For example, core network 102 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise a broadcast television network, e.g., a traditional cable provider network or an Internet Protocol Television (IPTV) network, as well as an Internet Service Provider (ISP) network. The network elements 118A-118C may serve as gateway servers or edge routers to interconnect the core network 102 with other networks 110, Internet 112, wireless access network 104, other access networks, and so forth. The core network 102 may also comprise an application server (AS) 120 and a database (DB) 128 that are configured to monitor conditions of the mobile devices 106 and 108 and to send instructions to mobile devices 106 and 108 when those conditions satisfy triggers for roaming, as discussed in further detail below. For ease of illustration, various additional elements of core network 102 are omitted from FIG. 1. For instance, core network 102 may also include other network elements that are not illustrated, such as television (TV) servers, content servers, application servers, and the like.

In addition, the network 100 may include a non-terrestrial network 126 that functions in a manner similar to the terrestrial wireless access network 104. For instance, the non-terrestrial network 126 may comprise an access network that provides broadband links via satellite, unmanned aerial vehicles, high-altitude platform systems, or any other yet to be developed future wireless/non-terrestrial network technology. While the present disclosure is not limited to any particular type of non-terrestrial network, in the illustrative example, non-terrestrial network 126 is shown as a satellite network. Thus, elements 122 and 124 may each comprise a satellite. In one example, the non-terrestrial network 126 may be controlled and/or operated by a same network service provider as the terrestrial wireless access network 104. In another example, the non-terrestrial network 126 may be controlled and/or operated by a different entity than the network service provider who operates the terrestrial wireless access network 104.

In one example, the AS 120 may be configured to monitor specified conditions of the mobile devices 106 and 108 and to send instructions to the mobile devices 106 and 108 that cause the mobile devices to disconnect from one of the terrestrial wireless access network 104 and the non-terrestrial network 126 and to connect to the other of the terrestrial wireless access network 104 and the non-terrestrial network 126 when the specified conditions satisfy a predefined trigger.

For instance, a specified condition may comprise a quality of experience metric such as network coverage, network loading, services, or cost of a connection connecting a mobile device 106 or 108 to an access network (e.g., terrestrial wireless access network 104 or non-terrestrial network 126). A specified condition could also comprise an altitude of a mobile device 106 or 108. When a value of the quality of experience metric falls below a predefined threshold value, or the altitude of the mobile device falls below or exceeds a predefined threshold altitude, this may indicate that the mobile device 106 or 108 should disconnect from one access network and connect to another access network.

As an example, mobile device 106 may belong to a user who is traveling by airplane. While the airplane is on the ground, the mobile device 106 may be connected to the terrestrial wireless access network 104. However, once the airplane takes off and begins to gain altitude, the quality of the connection to the terrestrial wireless access network 104 may degrade. In one example, when the altitude of the mobile device 106 is detected to exceed a predefined threshold altitude, or when the altitude of the mobile device 106 is detected to be increasing by more than a threshold rate of increase, the AS 120 may instruct the mobile device 106 to disconnect from the terrestrial wireless access network 104 and to connect to the non-terrestrial network 126. The non-terrestrial network 126 may provide a more reliable network connection at the mobile device's present altitude. Conversely, when the airplane begins its descent, the altitude of the mobile device 106 may be detected to fall below the predefined threshold altitude, or the altitude of the mobile device 106 may be detected to be decreasing by more than a threshold rate of decrease. In this case, the AS 120 may instruct the mobile device to disconnect from the non-terrestrial network 126 and to connect to the terrestrial wireless access network 104.

As another example, the mobile device 108 may belong to a user who is traveling in a remote physical location on the ground. For instance, the user may be traveling on a cruise ship in the middle of the ocean, or hiking in a remote forest. In such an instance, the coverage of the terrestrial wireless access network 104 may be such that the connection experienced by the mobile device 108 in the remote physical location is weak or unreliable. Moreover, no other terrestrial network may be able to provide a reliable connection in the remote location. In this case, the AS 120 may detect that the signal strength between the mobile device 108 and the gNodeB 116 is weaker than a predefined threshold signal strength and may instruct the mobile device 108 to instead connect to the non-terrestrial network 126 for a stronger signal.

As discussed above, other conditions and considerations may motivate roaming between the terrestrial wireless access network 104 and the non-terrestrial network 126. For instance, if the current loading on the terrestrial wireless access network 104 is greater than a predefined threshold loading, then the AS 120 may instruct a mobile device 106 or 108 to instead connect to the non-terrestrial network 126 to lessen the loading on the terrestrial wireless access network 104. In another example, a mobile device 106 or 108 may be connected to the non-terrestrial network 126, but the AS 120 may detect that the terrestrial wireless access network 104 can provide service to the mobile device 106 or 108 for a lower cost. Alternatively, the terrestrial wireless access network 104 and the non-terrestrial network 126 may be capable of providing varying levels of support for different services; some services may not be supported by certain types of networks, and the AS 120 may recommend the appropriate network based on the service that the mobile device 106 or 108 is trying to access.

Moreover, as discussed above, the same considerations that may motivate roaming between a terrestrial and a non-terrestrial network may also apply to roaming between different terrestrial networks or between different non-terrestrial networks. For instance, a mobile device 106 or 108 may roam from a first terrestrial network to a second terrestrial network, or from a first non-terrestrial network to a second non-terrestrial network, to alleviate network loading, obtain improved coverage, improve support for services, save costs, or the like.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Wireless access network 104 is not limited to a UMTS/UTRAN configuration. Non-terrestrial network 126 is not limited to a satellite network. Similarly, the present disclosure is not limited to an IP/MPLS network for VoIP telephony services, or any particular type of broadcast television network for providing television services, and so forth.

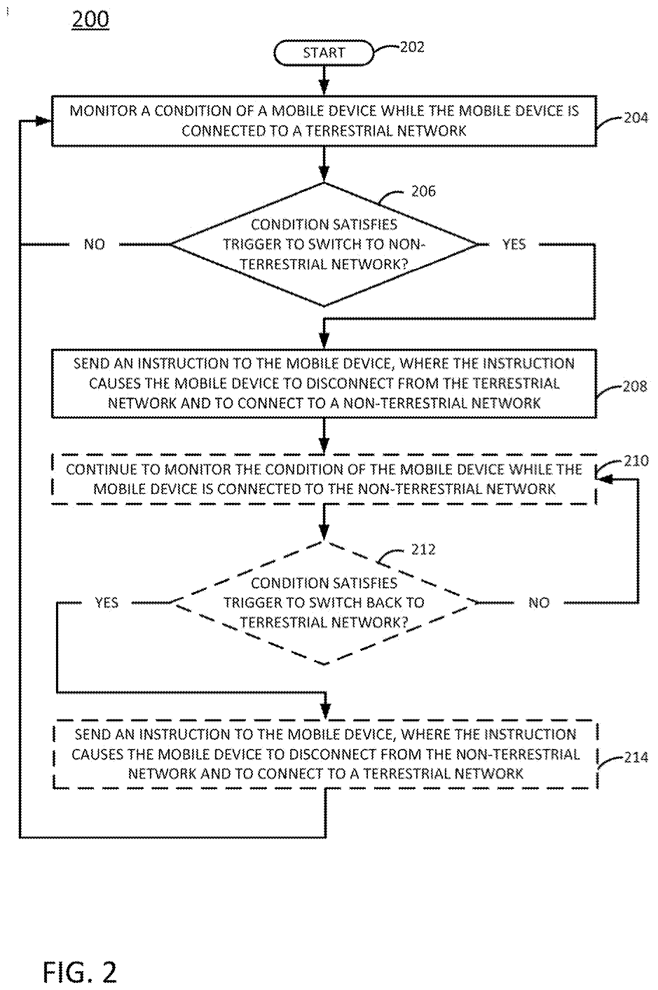

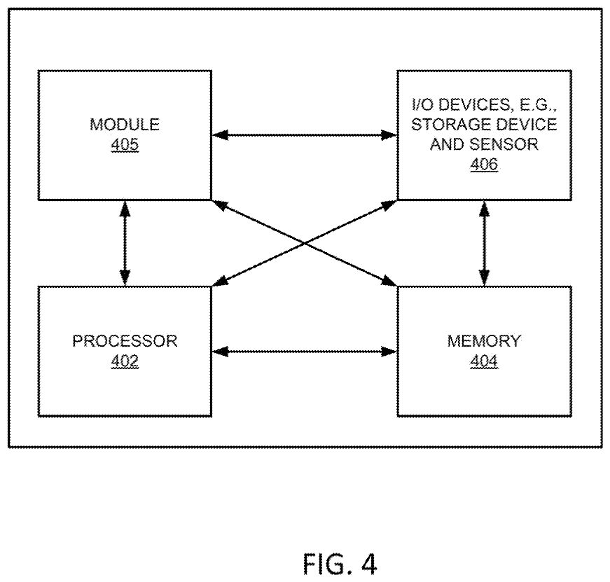

To further aid in understanding the present disclosure, FIG. 2 illustrates a flowchart of an example method 200 for enabling mobile device roaming between non-terrestrial and terrestrial mobile networks, in accordance with the present disclosure. In one example, the method 200 may be performed by an application server, such as the AS 120 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may monitor a condition of a mobile device while the mobile device is connected to a terrestrial network (TN).

As discussed above, a terrestrial network may comprise a network for which a majority, if not all, of the physical infrastructure is anchored to the Earth's surface, such as a 4G LTE or Wi-Fi network. Some 5G networks may also be considered terrestrial networks.

In one example, the mobile device may comprise a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), or the like. Thus, the mobile device is a device whose physical location may change.

In one example, the condition may comprise a quality of experience metric. For instance, the condition may comprise the strength of a signal received by the mobile device from a network element of the terrestrial network (e.g., from an eNode B or a gNodeB), which may be affected by the coverage of the terrestrial network (i.e., the geographical area served by the terrestrial network). In other words, the closer the mobile device is to the boundary of the geographic area covered by the terrestrial network, the weaker the signal strength may be.

In another example, the condition may comprise a bandwidth, packet loss, or latency experienced by the mobile device, which may be affected by the loading (e.g., network traffic) on the terrestrial network. For instance, if the terrestrial network is experiencing a high level of network traffic, then the bandwidth experienced by the mobile device may be relatively low (or the latency or packet loss experienced by the mobile device may be relatively high). Conversely, if the terrestrial network is experiencing a low level of network traffic, then the bandwidth experienced by the mobile device may be relatively high (or the latency or packet loss experienced by the mobile device may be relatively low).

In another example, the condition may comprise a cost of service. For instance, a mobile device may pay a fixed cost (e.g., x dollars per month) to connect to a “native” network (e.g., the network operated by the service provider to whose services the mobile device is subscribed). However, if the mobile device connects to a non-native network (e.g., a network operated by a service provider other than the service provider to whose services the mobile device is subscribed), then the mobile device may be required to pay additional fees to the operator of the non-native network.

In another example, the condition may comprise a current battery charge level of the mobile device. For instance, in most cases, the mobile device battery may be consumed at a slower rate by connecting to a terrestrial network rather than connecting to a non-terrestrial network. However, in certain physical locations, the mobile device battery may be consumed at a slower rate by connecting to a non-terrestrial network rather than connecting to a terrestrial network.

In another example, the condition may comprise service or application availability. For instance, the mobile device may require access to a service or application that cannot be supported by all networks or types of networks. As an example, a particular service or application may require 5G connectivity; earlier generation terrestrial networks may not be able to provide the infrastructure needed to support the particular service or application.

In another example, the condition may comprise an altitude of the mobile device. In this case, altitude may be tied in part to coverage. For instance, when the mobile device is located at a certain altitude (e.g., such as when a user of the mobile device is traveling on an airplane), the mobile device may be beyond the coverage area of a terrestrial network, or may experience weak signal strength.

In one example, the processing system may monitor the condition by collecting data about the condition from at least one of the mobile device and the terrestrial network. For instance, the mobile device may self-report one or more metrics related to the condition to the processing system on a periodic basis, on demand (e.g., in response to a query from the processing system), or in response to the occurrence of a predefined event (e.g., a value of the one or more metrics passing some predefined threshold value). As an example, the mobile device may report a current signal strength or bandwidth to the processing system when the value of the current signal strength or bandwidth falls below a predefined threshold value (potentially indicating weak network coverage).

Another example of an event-based reporting rule may be related to the altitude of the mobile device, as discussed above. For instance, if the mobile device is physically located on an airplane that has just taken off, then the strength of the signal that the mobile device detects from a connection to a network element of the terrestrial network (e.g., eNobeB or gNodeB) may become weaker as the altitude increases. When the mobile device detects that the strength of the signal has dropped below a predefined threshold signal level, the mobile device may automatically report its altitude to the processing system.

In another example, the terrestrial network may self-report one or more metrics related to the condition to the processing system on a periodic basis, on demand (e.g., in response to a query from the processing system), or in response to the occurrence of a predefined event (e.g., a number of data packets traversing the terrestrial network exceeding some predefined threshold number). As an example, the terrestrial network may report a number of data packets traversing the terrestrial network to the processing system when the number of data packets exceeds a predefined threshold number (potentially indicating a high level of loading on the terrestrial network).

In step 206, the processing system may determine whether the condition satisfies a trigger for switching to a non-terrestrial network (NTN).

For instance, as discussed above, the trigger may comprise a predefined threshold value for the condition, where the trigger is satisfied when a current value for the condition falls below or exceeds the threshold value (depending upon the nature of the condition). As an example, if the condition is signal strength or bandwidth, then the condition may satisfy the trigger when a current value of the signal strength or bandwidth falls below the threshold value (or falls below the signal strength or bandwidth provided by the non-terrestrial network). If the condition is latency or packet loss, then the condition may satisfy the trigger when a current value of the latency or packet loss exceeds the threshold value (or exceeds the latency or packet loss of the non-terrestrial network). If the condition is cost, then the condition may satisfy the trigger when the cost of connecting to the terrestrial network exceeds a threshold cost (and/or the cost of connecting to the non-terrestrial network falls below the cost of connecting to the terrestrial network). If the condition is the altitude or rate of increase in altitude, then the condition may satisfy the trigger when the current altitude or current rate of increase in altitude exceeds the threshold value (or threshold rate).

In another example, the trigger may comprise support for a service or application that the mobile device requires access to. In this case, the condition may satisfy the trigger when the terrestrial network is unable to provide the necessary support for the service or application to execute (and/or the non-terrestrial network is able to provide the necessary support).

In another example, the trigger may comprise a current battery charge level of the mobile device. For instance, if the current battery charge level is below a predefined threshold battery charge level, then the processing system may attempt to identify an alternative network (e.g., the non-terrestrial network) to which the mobile device may connect that will cause the charge level to decrease at a slower rate than if the mobile device were to remain connected to the terrestrial network.

If the processing system concludes in step 206 that the condition does not satisfy a trigger for switching to a non-terrestrial network, then the method 200 may return to step 204, and the processing system may continue to monitor the condition of the mobile device while the mobile device is connected to the terrestrial network.

That is, the terrestrial network may adequately support the current needs of the mobile device with respect to quality of experience and support for applications and services. In this case, switching to a non-terrestrial network may be unnecessary.

If, however, the processing system concludes in step 206 that condition satisfies a trigger for switching to a non-terrestrial network, then the method 200 may proceed to step 208.

In step 208, the processing system may send an instruction (e.g., a first instruction) to the mobile device, where the instruction causes the mobile device to disconnect from the terrestrial network and to connect a non-terrestrial network.

As discussed above, the non-terrestrial network may comprise a network for which at least a portion of the physical infrastructure is not anchored to the Earth's surface (e.g., a satellite network or a network that utilizes unmanned aerial vehicles or high-altitude platform systems to provide broadband links).

The instruction may identify (e.g., by name, network identifier, or other means) the specific non-terrestrial network to which the mobile device should connect in place of the terrestrial network. The instruction may further contain any credentials (e.g., passwords, tokens, or the like) that the mobile device may need to provide in order to connect to the non-terrestrial network.

In optional step 210 (illustrated in phantom), the processing system may continue to monitor the condition of the mobile device while the mobile device is connected to the non-terrestrial network.

The monitoring in step 210 may be performed in the same manner as the monitoring that is performed in step 204. For instance, the mobile device may self-report one or more metrics related to the condition to the processing system on a periodic basis, on demand (e.g., in response to a query from the processing system), or in response to the occurrence of a predefined event (e.g., a value of the one or more metrics passing some predefined threshold value). As an example, the mobile device may report a current signal strength or bandwidth to the processing system when the value of the current signal strength or bandwidth falls below a predefined threshold value (potentially indicating weak network coverage).

Another example of an event-based reporting rule may be related to the altitude of the mobile device, as discussed above. For instance, if the mobile device is physically located on an airplane that has begun its descent, the mobile device may automatically report the mobile device's altitude to the processing system when the mobile device detects that its altitude has dropped below a predefined threshold altitude.

In another example, the non-terrestrial network may self-report one or more metrics related to the condition to the processing system on a periodic basis, on demand (e.g., in response to a query from the processing system), or in response to the occurrence of a predefined event (e.g., a number of data packets traversing the non-terrestrial network exceeding some predefined threshold number). As an example, the non-terrestrial network may report a number of data packets traversing the non-terrestrial network to the processing system when the number of data packets exceeds a predefined threshold number (potentially indicating a high level of loading on the non-terrestrial network).

In optional step 212 (illustrated in phantom), the processing system may determine whether the condition satisfies a trigger for switching back to a terrestrial network.

In one example, the trigger for switching back to a terrestrial network may be the opposite or inverse of the trigger for switching to the non-terrestrial network. For instance, if the condition is the altitude or rate of decrease in altitude, then the condition may satisfy the trigger in step 212 when the current altitude falls below the threshold value or the current rate of decrease in altitude exceeds the threshold value (or threshold rate).

In another example, the condition may comprise the mobile device no longer requiring support for a service or application that is unsupported by a terrestrial network. In this case, the condition may satisfy the trigger when the mobile device closes or ceases to access the service or application.

In another example, the condition may be tied to a condition in an available terrestrial network, where the terrestrial network may not have been previously available based on the mobile device's physical location. For instance, if the condition is cost, then the condition may satisfy the trigger when a terrestrial network becomes available, and the cost of connecting to the terrestrial network falls below a threshold cost or falls below the cost of connecting to the non-terrestrial network.

In another example, if the condition is the battery charge level of the mobile device, then the processing system may attempt to identify an alternative network (e.g., the terrestrial network) to which the mobile device may connect that will cause the charge level to decrease at a slower rate than if the mobile device were to remain connected to the non-terrestrial network.

In another example, if the condition is signal strength or bandwidth, then the condition may satisfy the trigger when a terrestrial network becomes available, and a current value of the signal strength or bandwidth provided by the terrestrial network at least meets the threshold value (or is greater than the signal strength or bandwidth provided by the non-terrestrial network). If the condition is latency or packet loss, then the condition may satisfy the trigger when a terrestrial network becomes available, and a current value of the latency or packet loss in the terrestrial network falls below the threshold value (or is less than the latency or packet loss in the non-terrestrial network).

If the processing system concludes in step 212 that the condition does not satisfy a trigger for switching back to a terrestrial network, then the method 200 may return to step 210, and the processing system may continue to monitor the condition of the mobile device while the mobile device is connected to the non-terrestrial network. That is, the mobile device may maintain the connection to the non-terrestrial network.

If, however, the processing system concludes in step 212 that condition satisfies a trigger for switching back to a terrestrial network, then the method 200 may proceed to step 214. In optional step 214 (illustrated in phantom), the processing system may send an instruction (e.g., a second instruction) to the mobile device, where the instruction causes the mobile device to disconnect from the terrestrial network and to connect a non-terrestrial network.

The instruction may identify (e.g., by name, network identifier, or other means) the specific terrestrial network to which the mobile device should connect in place of the non-terrestrial network. The instruction may further contain any credentials (e.g., passwords, tokens, or the like) that the mobile device may need to provide in order to connect to the terrestrial network.

In another example, the instruction may cause the mobile device to search for terrestrial networks for which a signal can be detected by the mobile device. The mobile device may report any terrestrial networks that are detected to the processing system, along with the respective strengths of the signals that are detected from those terrestrial networks. Based on the report from the mobile device, the processing system may select a terrestrial network and initiate a handoff from the non-terrestrial network to the selected terrestrial network.

The terrestrial network to which the processing system instructs the mobile device to connect in step 214 may or may not be the same terrestrial network to which the mobile device was previously connected (e.g., before connecting to the non-terrestrial network in response to the instructions sent in step 208).

The method 200 may then return to step 204 and continue as discussed above to monitor the condition of the mobile device while the mobile device is connected to the terrestrial network.

Thus, the processing system may continue to iterate through some or all of steps 204-214 for as long as the mobile device is power on and/or is set to search for a network connection (e.g., is not set in airplane mode or a similar mode of operation). As such, the processing system may continually monitor one or more conditions of the mobile device and/or the network to which the mobile device is connected, and may continually optimize the mobile device's network connection so that the mobile device may continue to maintain network connectivity and to use mobile applications and services in a substantially uninterrupted manner, regardless of the mobile device's physical location.

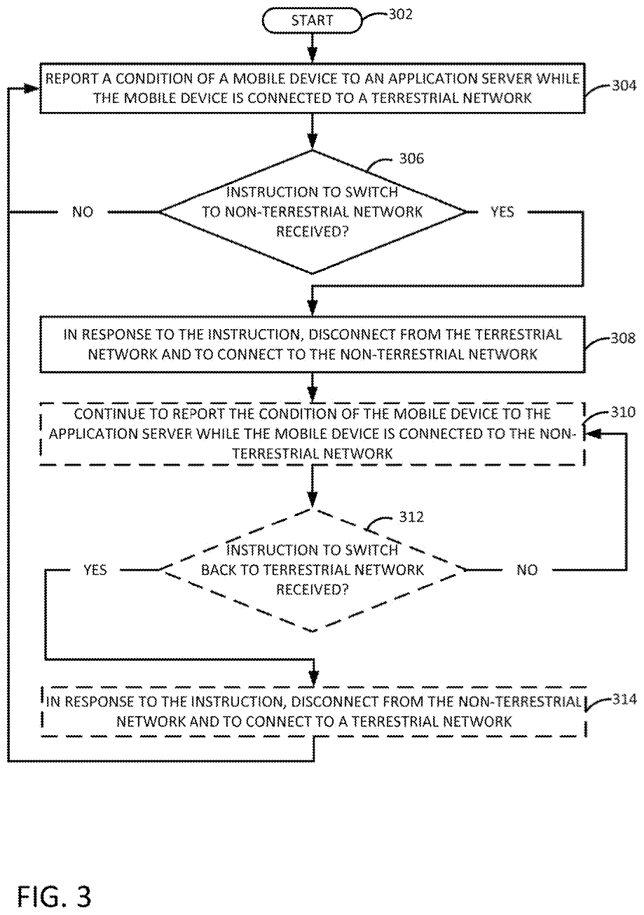

FIG. 3 illustrates a flowchart of an example method 300 for enabling mobile device roaming between non-terrestrial and terrestrial mobile networks, in accordance with the present disclosure. In one example, the method 300 may be performed by a mobile device, such as the mobile device 106 or 108 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may report a condition of a mobile device to an application server while the mobile device is connected to a terrestrial network.

In one example, the processing system may be part of the mobile device. The mobile device may comprise a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), or the like. Thus, the mobile device is a device whose physical location may change.

The terrestrial network may comprise a network for which a majority, if not all, of the physical infrastructure is anchored to the Earth's surface, such as a 4G LTE or Wi-Fi network. Some 5G networks may also be considered terrestrial networks.

In one example, the condition may comprise a quality of experience metric. For instance, the condition may comprise the strength of a signal received by the mobile device from a network element of the terrestrial network (e.g., from an eNode B or a gNodeB), which may be affected by the coverage of the terrestrial network (i.e., the geographical area served by the terrestrial network). In other words, the closer the mobile device is to the boundary of the geographic area covered by the terrestrial network, the weaker the signal strength may be.

In another example, the condition may comprise a bandwidth, packet loss, or latency experienced by the mobile device, which may be affected by the loading (e.g., network traffic) on the terrestrial network. For instance, if the terrestrial network is experiencing a high level of network traffic, then the bandwidth experienced by the mobile device may be relatively low (or the latency or packet loss experienced by the mobile device may be relatively high). Conversely, if the terrestrial network is experiencing a low level of network traffic, then the bandwidth experienced by the mobile device may be relatively high (or the latency or packet loss experienced by the mobile device may be relatively low).

In another example, the condition may comprise a cost of service. For instance, a mobile device may pay a fixed cost (e.g., x dollars per month) to connect to a “native” network (e.g., the network operated by the service provider to whose services the mobile device is subscribed). However, if the mobile device connects to a non-native network (e.g., a network operated by a service provider other than the service provider to whose services the mobile device is subscribed), then the mobile device may be required to pay additional fees to the operator of the non-native network.

In another example, the condition may comprise service or application availability. For instance, the mobile device may require access to a service or application that cannot be supported by all networks or types of networks. As an example, a particular service or application may require 5G connectivity; earlier generation terrestrial networks may not be able to provide the infrastructure needed to support the particular service or application.

In another example, the condition may comprise a current battery charge level of the mobile device. For instance, if the current battery charge level is below a predefined threshold battery charge level, then the processing system may attempt to identify an alternative network (e.g., the non-terrestrial network) to which the mobile device may connect that will cause the charge level to decrease at a slower rate than if the mobile device were to remain connected to the terrestrial network.

In another example, the condition may comprise an altitude of the mobile device. In this case, altitude may be tied in part to coverage. For instance, when the mobile device is located at a certain altitude (e.g., such as when a user of the mobile device is traveling on an airplane), the mobile device may be beyond the coverage area of a terrestrial network, or may experience weak signal strength.

In one example, the processing system may self-report one or more metrics related to the condition to the application server on a periodic basis, on demand (e.g., in response to a query from the application server), or in response to the occurrence of a predefined event (e.g., a value of the one or more metrics passing some predefined threshold value). As an example, the processing system may report a current signal strength or bandwidth to the application server when the value of the current signal strength or bandwidth falls below a predefined threshold value (potentially indicating weak network coverage).

Another example of an event-based reporting rule may be related to the altitude of the mobile device, as discussed above. For instance, if the mobile device is physically located on an airplane that has just taken off, then the strength of the signal that the mobile device detects from a connection to a network element of the terrestrial network (e.g., eNobeB or gNodeB) may become weaker as the altitude increases. When the mobile device detects that the strength of the signal has dropped below a predefined threshold signal level, the processing system may automatically report the mobile device's altitude to the application server.

In some cases, the altitude of the mobile device may increase too rapidly for the processing system to report the altitude to the application server before the connection to the network element is lost completely. In one example, when the signal is lost before the processing system can report the altitude, the processing system may proceed directly to step 308, discussed in further detail below, and connect to a non-terrestrial network for which the processing system can detect a signal.

In step 306, the processing system may determine whether an instruction (e.g., a first instruction) to switch to a non-terrestrial network has been received.

For instance, as discussed in connection with the method 200, the application server may instruct the processing system to switch from a terrestrial network to a non-terrestrial network (or vice versa) in response to some predefined trigger being satisfied by the condition. As discussed above, the trigger may comprise a predefined threshold value for the condition, where the trigger is satisfied when a current value for the condition falls below or exceeds the threshold value (depending upon the nature of the condition). As an example, if the condition is signal strength or bandwidth, then the condition may satisfy the trigger when a current value of the signal strength or bandwidth falls below the threshold value (or falls below the signal strength or bandwidth provided by the non-terrestrial network). If the condition is latency or packet loss, then the condition may satisfy the trigger when a current value of the latency or packet loss exceeds the threshold value (or exceeds the latency or packet loss of the non-terrestrial network). If the condition is cost, then the condition may satisfy the trigger when the cost of connecting to the terrestrial network exceeds a threshold cost (and/or the cost of connecting to the non-terrestrial network falls below the cost of connecting to the terrestrial network). If the condition is the altitude or rate of increase in altitude, then the condition may satisfy the trigger when the current altitude or current rate of increase in altitude exceeds the threshold value (or threshold rate).

In another example, the trigger may comprise support for a service or application that the mobile device requires access to. In this case, the condition may satisfy the trigger when the terrestrial network is unable to provide the necessary support for the service or application to execute (and/or the non-terrestrial network is able to provide the necessary support).

If the processing system concludes in step 306 that an instruction to switch to a non-terrestrial network has not been received, then the processing system may return to step 304 and may continue to report the condition of the mobile device to the application server while the mobile device is connected to the terrestrial network, as discussed above.

That is, the terrestrial network may adequately support the current needs of the mobile device with respect to quality of experience and support for applications and services. In this case, switching to a non-terrestrial network may be unnecessary.

If, however, the processing system concludes in step 306 that an instruction to switch to a non-terrestrial network has been received, then the processing system may proceed to step 308.

In step 308, the processing system may disconnect, in response to the instruction, from the terrestrial network and connect to the non-terrestrial network.

As discussed above, the non-terrestrial network may comprise a network for which at least a portion of the physical infrastructure is not anchored to the Earth's surface (e.g., a satellite network or a network that utilizes unmanned aerial vehicles or high-altitude platform systems to provide broadband links).

The instruction may identify (e.g., by name, network identifier, or other means) the specific non-terrestrial network to which the processing system should connect in place of the terrestrial network. The instruction may further contain any credentials (e.g., passwords, tokens, or the like) that the processing system may need to provide in order to connect to the non-terrestrial network.

In optional step 310 (illustrated in phantom), the processing system may continue to report the condition of the mobile device to the application server while the mobile device is connected to the non-terrestrial network.

The reporting performed in step 310 may be performed in the same manner as the reporting that is performed in step 304. For instance, the processing system may self-report one or more metrics related to the condition to the mobile device on a periodic basis, on demand (e.g., in response to a query from the application server), or in response to the occurrence of a predefined event (e.g., a value of the one or more metrics passing some predefined threshold value). As an example, the processing system may report a current signal strength or bandwidth to the application server when the value of the current signal strength or bandwidth falls below a predefined threshold value (potentially indicating weak network coverage).

Another example of an event-based reporting rule may be related to the altitude of the mobile device, as discussed above. For instance, if the mobile device is physically located on an airplane that has begun its descent, the processing system may automatically report the mobile device's altitude to the application server when the mobile device detects that its altitude has dropped below a predefined threshold altitude.

In optional step 312 (illustrated in phantom), the processing system may determine whether an instruction (e.g., a second instruction) to switch to back to a terrestrial network has been received.

In some cases, the application server may, after a period of the processing system being connected to the non-terrestrial network, detect a trigger that should result in the processing system connecting back to a terrestrial network (e.g., the same terrestrial network to which the processing system was connected before switching in step 308 or a different terrestrial network). In one example, a trigger for switching back to a terrestrial network may be the opposite or inverse of the trigger for switching to the non-terrestrial network. For instance, if the condition is the altitude or rate of decrease in altitude, then the condition may satisfy the trigger for switching back to the terrestrial network when the current altitude falls below the threshold value or the current rate of decrease in altitude exceeds the threshold value (or threshold rate).

In another example, the condition may comprise the mobile device no longer requiring support for a service or application that is unsupported by a terrestrial network. In this case, the condition may satisfy the trigger when the mobile device closes or ceases to access the service or application.

In another example, if the condition is the battery charge level of the mobile device, then the processing system may attempt to identify an alternative network (e.g., the terrestrial network) to which the mobile device may connect that will cause the charge level to decrease at a slower rate than if the mobile device were to remain connected to the non-terrestrial network.

In another example, the condition may be tied to a condition in an available terrestrial network, where the terrestrial network may not have been previously available based on the mobile device's physical location. For instance, if the condition is cost, then the condition may satisfy the trigger when a terrestrial network becomes available, and the cost of connecting to the terrestrial network falls below a threshold cost or falls below the cost of connecting to the non-terrestrial network.

In another example, if the condition is signal strength or bandwidth, then the condition may satisfy the trigger when a terrestrial network becomes available, and a current value of the signal strength or bandwidth provided by the terrestrial network at least meets the threshold value (or is greater than the signal strength or bandwidth provided by the non-terrestrial network). If the condition is latency or packet loss, then the condition may satisfy the trigger when a terrestrial network becomes available, and a current value of the latency or packet loss in the terrestrial network falls below the threshold value (or is less than the latency or packet loss in the non-terrestrial network).

If the processing system concludes in step 312 that an instruction to switch back to a terrestrial network has not been received, then the processing system may return to step 310 and may continue to report the condition of the mobile device to the application server while the mobile device is connected to the non-terrestrial network, as discussed above. That is, the processing system may maintain the connection to the non-terrestrial network.

If, however, the processing system concludes in step 312 that an instruction to switch back to a terrestrial network has been received, then the processing system may proceed to step 314. In optional step 314 (illustrated on phantom), the processing system may disconnect, in response to the instruction, from the non-terrestrial network and connect to a terrestrial network.

The instruction may identify (e.g., by name, network identifier, or other means) the specific terrestrial network to which the processing system should connect in place of the non-terrestrial network. The instruction may further contain any credentials (e.g., passwords, tokens, or the like) that the processing system may need to provide in order to connect to the terrestrial network.

In another example, the instruction may cause the processing system to search for terrestrial networks for which a signal can be detected. The processing system may report any terrestrial networks that are detected to the application server and/or to the non-terrestrial network, along with the respective strengths of the signals that are detected from those terrestrial networks. Based on the report from the processing system, the application server or non-terrestrial network may select a terrestrial network and initiate a handoff to the selected terrestrial network.

The terrestrial network to which the processing system connects in step 314 may or may not be the same terrestrial network to which the processing system was previously connected (e.g., before connecting to the non-terrestrial network in response to the instructions sent in step 308).

The method 300 may then return to step 304 and continue as discussed above to report the condition of the mobile device while the mobile device is connected to the terrestrial network.

In one alternate embodiment, the present method for enabling mobile device roaming between non-terrestrial and terrestrial mobile networks will account for governmental regulations and controls (e.g., federal governmental authority, state governmental authority, or local governmental authority). For example, some governmental regulations may dictate that network access (whether terrestrial or non-terrestrial) by mobile devices may be placed on hold or suspended during critical operational phases of a vehicle (e.g., altitude based restrictions such as during takeoffs and landings of an aircraft or location based restrictions such as within ten (10) miles of an airport and the like). Thus, the present method for enabling mobile device roaming between non-terrestrial and terrestrial mobile networks will be modified when such restrictions are encountered (e.g., the method is temporarily suspended (e.g., turning on the airplane mode of the mobile device, terminating any existing terrestrial and/or non-terrestrial network access, and the like)).

Although not expressly specified above, one or more steps of the method 200 or method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, an application server (such as might be used to perform the method 200) or (or a mobile device (such as might be used to perform the method 300) could be implemented as illustrated in FIG. 4.

As depicted in FIG. 4, the system 400 comprises a hardware processor element 402, a memory 404, a module 405 for enabling mobile device roaming between non-terrestrial and terrestrial mobile networks, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for enabling mobile device roaming between non-terrestrial and terrestrial mobile networks may include circuitry and/or logic for performing special purpose functions relating to monitoring the conditions of a mobile device that is connected to a wireless (terrestrial or non-terrestrial) network. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for enabling mobile device roaming between non-terrestrial and terrestrial mobile networks (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for enabling mobile device roaming between non-terrestrial and terrestrial mobile networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
monitoring, by a processing system including at least one processor, a condition of a mobile device while the mobile device is connected to a terrestrial network;
determining, by the processing system, that the condition satisfies a trigger for switching to a non-terrestrial network; and
sending, by the processing system in response to the determining, a first instruction to the mobile device, where the first instruction causes the mobile device to disconnect from the terrestrial network and to connect to a non-terrestrial network.

2. The method of claim 1, wherein the condition comprises a strength of a signal received by the mobile device from a network element of the terrestrial network.

3. The method of claim 2, wherein the condition satisfies the trigger when a current value of the strength of the signal falls below a predefined threshold value.

4. The method of claim 1, wherein the condition comprises a bandwidth experienced by the mobile device while connected to the terrestrial network.

5. The method of claim 4, wherein the condition satisfies the trigger when a current value of the bandwidth falls below a predefined threshold value.

6. The method of claim 1, wherein the condition comprises at least one of: a packet loss experienced by the mobile device while connected to the terrestrial network or a latency experienced by the mobile device while connected to the terrestrial network.

7. The method of claim 6, wherein the condition satisfies the trigger when a current value of the packet loss or a current value of the latency exceeds a predefined threshold value.

8. The method of claim 1, wherein the condition comprises at least one of: a cost to the mobile device of connecting to the terrestrial network or a cost to the mobile device of connecting to the non-terrestrial network.

9. The method of claim 8, wherein the condition satisfies the trigger when the cost to the mobile device of connecting to the non-terrestrial network is less than the cost to the mobile device of connecting to the terrestrial network.

10. The method of claim 1, wherein the condition comprises a current battery charge level of the mobile device.

11. The method of claim 10, wherein the condition satisfies the trigger when the current battery charge level of the mobile device falls below a predefined threshold battery charge level, and a connection to the non-terrestrial network will consume the current battery charge level more slowly than a connection to the terrestrial network.

12. The method of claim 1, wherein the condition comprises an availability of a service or an application via the terrestrial network.

13. The method of claim 12, wherein the condition satisfies the trigger when the service or application is unavailable via the terrestrial network but available via the non-terrestrial network.

14. The method of claim 1, wherein the condition comprises an altitude of the mobile device.

15. The method of claim 14, wherein the condition satisfies the trigger when the altitude of the mobile device exceeds a predefined threshold altitude.

16. The method of claim 1, wherein the condition comprises a rate of increase of an altitude of the mobile device.

17. The method of claim 16, wherein the condition satisfies the trigger when the rate of increase of the altitude of the mobile device exceeds a predefined threshold rate of increase.

18. The method of claim 1, further comprising:
continuing, by the processing system, to monitor the condition of the mobile device while the mobile device is connected to the non-terrestrial network;
determining, by the processing system, that the condition satisfies a trigger for switching back to a terrestrial network access; and
sending, by the processing system in response to the determining that the condition satisfies the trigger for switching back, a second instruction to the mobile device, where the second instruction causes the mobile device to disconnect from the non-terrestrial network and to connect to the terrestrial network or another terrestrial network.

19. A non-transitory computer-readable medium storing instructions which, when executed by a processing system including at least one processor, cause the processing system to perform operations, the operations comprising:
monitoring a condition of a mobile device while the mobile device is connected to a terrestrial network;
determining that the condition satisfies a trigger for switching to a non-terrestrial network; and
sending, in response to the determining, a first instruction to the mobile device, where the first instruction causes the mobile device to disconnect from the terrestrial network and to connect to a non-terrestrial network.

20. A device comprising:
a processing system including at least one processor; and
a computer-readable medium storing instructions which, when executed by the processing system, cause the processing system to perform operations, the operations comprising:
monitoring a condition of a mobile device while the mobile device is connected to a terrestrial network;
determining that the condition satisfies a trigger for switching to a non-terrestrial network; and
sending, in response to the determining, a first instruction to the mobile device, where the first instruction causes the mobile device to disconnect from the terrestrial network and to connect to a non-terrestrial network.
